(19) United States
(12) Patent Application Publication
(10) Pub. No.: US 2007/0192838 A1
(43) Pub. Date: Aug. 16, 2007

(54) Management of user data

(75) Inventors: Pekka Laitinen, Helsinki (FI); Silke Holtmanns, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/699,469

(22) Filed: Jan. 30, 2007

Related U.S. Application Data
(60) Provisional application No. 60/762,855, filed on Jan. 30, 2006.

(51) Int. Cl. H04L 9/32

(52) U.S. Cl. 726/4

(57) ABSTRACT

A method and arrangements for managing user security data stored in a database of a communications system. In the method a user equipment transmits a request to manage the user security data, the user equipment is authenticated, after which an application entity can manage user security data in the database that associates with the user by communicating data between the application entity and the database connected to the communications system.

### CROSS REFERENCE TO RELATED APPLICATIONS

This application claims the benefit of U.S. Provisional Application Ser. No. 60/762,855, filed on Jan. 30, 2006. The information contained in the provisional application is hereby incorporated by reference.

### BACKGROUND OF THE INVENTION

1. Field of the Invention

The present disclosure relates to authentication in a communications system, and more particularly, but not exclusively, to management of user security data.

2. Description of the Related Art

A communication system can be seen as a facility that enables communication sessions between entities such as user equipment and/or other nodes associated with the communication system. The communication may comprise, for example, communication of voice, data, multimedia and so on. An user equipment connected to a communication system may, for example, be provided with a two-way telephone call or multi-way conference call or with a data connection. In addition voice call services, various other services, for example enhanced content services such as multimedia services or other data services, security services may be provided for a user. An user equipment may communicate data to and from a server entity, or between two or more user equipments.

A communication system typically operates in accordance with a given standard or specification, which sets out what the various entities associated with the system are permitted to do and how that should be achieved. Communication protocols, parameters, reference points and interfaces, which shall be used for a connection are typically defined by the standards or specifications.

Communication systems proving wireless communication for user equipment are known. These systems are commonly referred to as mobile systems, although in certain systems the mobility may be restricted to substantially small areas. An example of the mobile systems is the public land mobile network (PLMN). Another example is a mobile system that is based, at least partially, on use of communication satellites. Mobile communications may also be provided by means of other types of systems, such as by means of wireless local area networks (WLAN), Personal Area Networks (PAN) or Wide Area Networks (WAN).

In a wireless system an access node provides user equipment with access to the communication system. An user equipment may be in wireless communication with two or more access nodes at the same time. Communication on the wireless interface between the user equipment and the access node(s) can be based on an appropriate communication protocol. Examples of the various wireless access systems include the CDMA (Code Division Multiple Access), WCDMA (Wide-band CDMA), TDMA (Time Division Multiple Access), FDMA (Frequency Division Multiple Access), or SDMA (Space Division Multiple Access), Institute of Electrical and Electronics Engineers (IEEE) 802.11, DECT (Digital Enhanced Cordless Communication) and further developments and hybrids thereof.

The operation of the network apparatus is controlled by an appropriate control arrangement commonly including a number of various control entities. One or more gateways or intermediate servers may also be provided for connecting a network to other networks or hiding network internal details from external nodes. For example, a PLMN network may be connected to other mobile or fixed line communication networks or data communication networks such as an IP (Internet Protocol) and/or other packet data networks.

A user or the user equipment may need to be authenticated before he/she is allowed to access or otherwise use various applications and services. This may be required for security and privacy reasons, but also to enable correct billing of the service usage. For example, it may need to be verified that the user is whoever he/she claims to be, that the user has the right to use a certain service, that the user can be provided with an access to sensitive information and so on. In an authentication, a user can be identified based on various identifiers.

Various authentication mechanisms are already in place, or have been proposed. A non-limiting example is an authentication mechanism proposed by the third generation partnership project (3GPP) called the ‘Generic Authentication Architecture’ (GAA) or the GAA version defined by the Third Generation Partnership Project 2 (3GPP2). The GM is indented to be used as a security procedure for various applications and services for users of mobile user equipment, such as mobile stations for cellular systems. The GM is intended to be based on secret user identities that are stored on specific secure storage entities provided in association with the user equipment and subscriber databases. The secure storage entity of a user equipment may be provided by an appropriate security function, for example a security module, an identification module or a trusted platform. The subscriber database may be provided by an appropriate network entity, for example a Home Location Register (HLR) or Home Subscriber Server (HSS). Typically user data for each user is stored in a user profile. The secure user identity storage entities and the subscriber database entities have been controlled by the operators who issue the user identities and who typically run and own the subscriber databases. The secure user identity storage may be part of the HSS or HLR or be a separate entity that is connected to the HLR or HSS.

However, proposals for the authentication systems, such as the GAA, are based on subscriber databases that are under direct control of and manageable only by the operators. Operators are also assumed to have specific management arrangements of their own. User data, for example user security settings cannot be managed by other parties, for example service applications or other network application functions (NAFs) residing for example in trusted third party networks.

The management by other parties might, nevertheless, be desirable in certain occasions. For example, the burden to manage a subscriber database by non-standardized operator specific arrangements might become substantial, and an operator may not be prepared or even have the capability to take responsibility of the management. This situation can be exemplified with reference to application functions that also provide services such as those called Liberty Alliance Identity Provider services. A possibility to allow trusted third parties, for example partner operators, to update user security data in an operator database using for example GAA specific protocols might ease the maintenance burden of the operator for frequent management activities. Because of the unpredictability in the number and type of services and/or service provides the operators may not always have the resources to manage the subscriber databases in all occasions.

A submission to 3GPP SA3 mailing list, item number S3-050705 describes some examples of user security settings (USS) insert/update/delete procedures which can be initiated by a network application function (NAF) in order to remove some of the burden of maintaining the USS from the communication network operators. Although these examples enable a trusted NAF to manage the user security setting (USS) stored within the home subscriber server (HSS) the examples provide fail to address the problem of allowing the end user control over the information stored.

Furthermore such a procedure as described in S3-050705 does not enable the operator or to provide specific user personalized services allocated via the chosen USS and therefore does not enable the provision of spam or virus protection. Also such application server driven management of USS information does not permit in specific legislation environments the requirements of the operator/government to be easily met.

It is noted that the problem is not limited to wireless systems, but may occur in any communication environment wherein the user may access services and applications by user equipment.

### SUMMARY OF THE INVENTION

Embodiments of the present invention aim to address one or several of the above problems.

There is provided according to the invention a method for managing from a user equipment user security data stored in a database of a communications system, comprising: receiving from the user equipment a request to manage the user security data; authenticating the user equipment in an application entity; and managing by an application entity user security data in the database associated with the user equipment by communicating data between the application entity and the database connected to the communications system.

The step of communicating data may comprise a first step of communicating data between the application entity and a security management function and a second step of communicating data between the security management function and the database.

The method may comprise modifying user data by the security management function.

The security management function may comprise a bootstrapping function.

The step of communicating data may comprise communicating data on an interface directly connecting the application entity and the user database.

The step of managing user security data may comprise: modifying a copy of the user security data in a second database within the application entity; communicating the copy of the user security data from the second database to the database managed by the main controller; and modifying the user security data in the database managed by the main controller based on the copy of the user security data from the second database.

The step of communicating the copy of the user security data may occur in response to a predefined event.

The predefined event may comprise an end of session between the application entity and the user.

The step of authenticating may comprise authenticating the user in a bootstrapping function based on security keys.

The main controller may comprise a network operator.

The database controlled by the main controller is preferably provided in a home subscriber server.

The step of managing may be performed when the user starts using a new service application.

The method may comprise authentication of the user in a generic authentication architecture (GAA) in accordance with specifications of the third generation partnership project (3GPP).

The user security data may comprise user security settings.

The user data may comprise service specific user security settings of a generic bootstrapping architecture user security settings.

The method may comprise fetching information regarding a user database to be managed in a communications system comprising a plurality of user databases.

The method may comprise fetching said information from a subscriber locator function to a security management function.

According to a second aspect of the invention there is provided a computer program comprising program code means adapted to perform any of steps described above when the program is run on a computer.

According to a third aspect of the invention there is provided a node for a communications system where user security data is stored in a database stored on a second node, the node being configured to receive an input from a user equipment to manage user security data associated with an authenticated user, and to manage user security data associated with the authenticated user in the database by communicating data to the database connected to the communications system.

The node may be configured to modify user security data in a second database stored in a third node for later communication from the second database to the database stored on the second node.

The third node may comprise a security management function.

The security management function may comprise a bootstrapping function.

The third node may comprise the user database, and the node is preferably provided with an interface directly connecting the node and the user database.

The node may be configured to manage user security data when the user starts using a new application.

The node may be configured to authenticate the user based on a generic authentication architecture (GAA) in accordance with specifications of the third generation partnership project (3GPP) or third generation partnership project 2 (3GPP2).

The user security data may comprise user security settings.

The user security data may comprise service specific user security settings of a generic bootstrapping architecture user security settings.

The node may comprise a USS management server.

### BRIEF DESCRIPTION OF DRAWINGS

For better understanding of the present invention, reference will now be made by way of example to the accompanying drawings in which:

FIG. 1 shows a communication system wherein the present invention may be embodied;

FIG. 2 shows the schematic view of a communications architecture wherein the present invention may be embodied;

FIG. 3 shows a flowchart of both automatic and manual exemplifying processes of USS management as carried out in a first embodiment of the present invention;

FIG. 4 shows a flowchart of both automatic and manual exemplifying processes of USS management as carried out in a second embodiment of the present invention;

FIG. 5 shows a flowchart of both automatic and manual exemplifying processes of USS management as carried out in a third embodiment of the present invention; and

FIG. 6 shows a flowchart of automatic exemplifying processes of USS management as carried out in a fourth embodiment of the invention.

### DETAILED DESCRIPTION OF THE PREFERRED EMBODIMENTS

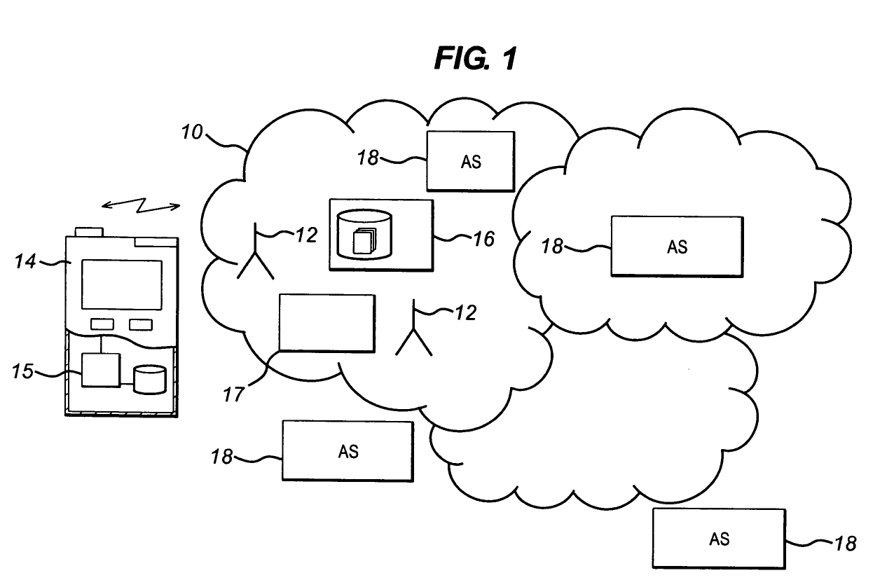

Some exemplifying and non-limiting embodiments of the invention are discussed below with reference to a mobile communication network such as a public landline mobile network (PLMN). Before explaining these in more detail, a communication system comprising at least a PLMN is briefly explained with reference to FIG. 1.

In a PLMN 10 a number of base stations 12 are arranged to wirelessly transmit signals to and receive signals from a plurality of mobile user equipment. Likewise, an mobile user equipment 14 is able to transmit wireless signals to and receive signals from base stations. The operation of the network 10 is typically controlled by means of appropriate controller entities. Data required for the operation of the PLMN is typically stored in appropriate data storage entities. FIG. 1 shows only a data storage 16 configured to store subscriber i.e. user data. Non-limiting examples of such data storages include various home location registers (HLR) and home subscriber servers (HSS).

The user equipment (UE) 14 can be provided by any appropriate user terminal. The user equipment may contain or have access to a secure environment. In a mobile communications system, the user equipment constitutes a mobile terminal, for example a mobile telephone, a personal digital assistant (PDA) or a mobile PC (personal computer), or the like. For use in a wireless communications system, the user equipment comprises receive and transmit circuitry and means for receiving and transmitting wireless signals for implementing calls and other signaling channels so that it is enabled to communicate with the base stations 12, for example to make voice call and to send and receive data. The user equipment may also be enabled to process control instructions it may receive from the network and to send control information to the network.

A user may access various applications, for example service applications via the network he or she has access to. An application may be provided by a provider entity, for example any of service provider application servers 18. It is noted that the application servers (AS) need only be connected to the mobile network, but are not necessarily a part of the mobile network. This means that the operator of the network 10 may not necessarily have any or may only have a limited control on the operation of an application provider. Furthermore, a communication system may be provided by a plurality of different communication networks. Thus the application provider entity may be connected to another network than the network the user subscribes to.

A user or the user equipment commonly needs to be authenticated before he/she is allowed to access or otherwise use various applications and services via the network. FIG. 1 shows a security management server 17 adapted for user authentication. The security management server may be capable of key generation. For example, the server 17 may provide a bootstrapping function.

A user can be identified by the security management server 17 based on various identifiers. These can be divided into public and private or secret identifiers. The secret identifiers are typically only known by the operator whereas the public identifiers may be made public. Non-limiting examples of secret user identities include International Mobile Subscriber Identity (IMSI) and Internet Protocol Multimedia Private Identity (IMPI). Non-limiting examples of public identities include Mobile Subscriber Integrated System Digital Number (MSISDN) and IP Multimedia Public Identity (IMPU).

To maintain the identity information a mobile user equipment may be provided with an identity module 15. The identity module is commonly understood to refer to the storage of a secure identifier that is arranged to enable the networks to ensure that the user and the user equipment are who they claim to be. A user identity module may contain a number of security and other applications. Well-known non-limiting examples of user identity modules are the Subscriber Identity Module (SIM) of the 2G GSM and User Identity Circuit Card (UICC) of the 3G systems or trusted platforms. The user identity module might reside directly in the access device or be accessible from the user equipment providing the network access. User identity modules and the subscriber data storage of the network may store user identities and other shared'secrets. A user may have several kinds of user identities that are stored in a user identity module and the subscriber data storage. For example, an IP Multimedia Private Identity (IMPI) may be used inside a security domain whereas a set of IMPUs (IM PUblic Identities) may be used outside the security domain. A user identity module may hold shared secrets with the subscriber data storage and generate security keys from the shared secret. These keys may then be used in creation of trusted connections between the user equipment and an application in operations such as bootstrapping.

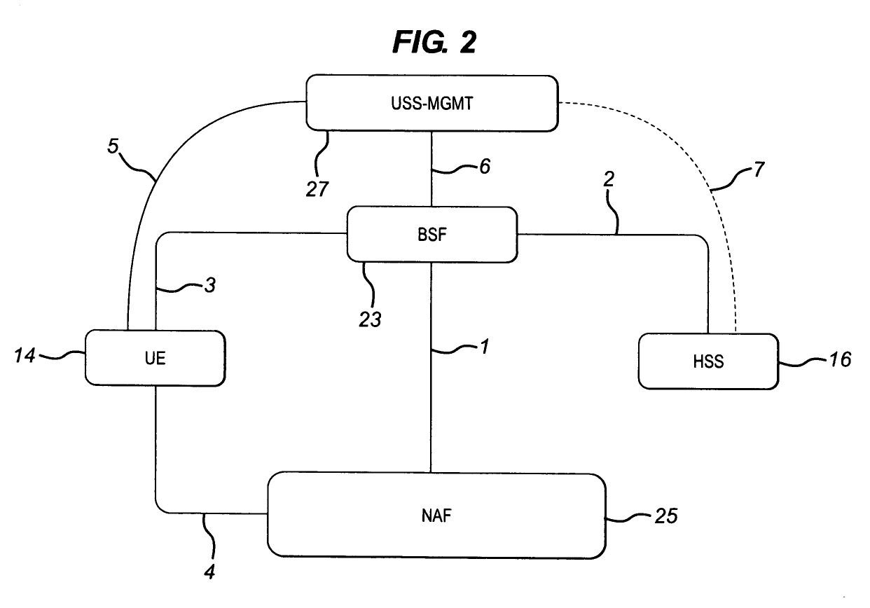

FIG. 2 shows an example of the server architecture within which the embodiments of the present invention operate. More particularly, FIG. 2 is a schematic block diagram of an improved arrangement, which in its non improved form is known as a generic authentication architecture (GAA) in accordance with the 3GPP system.

The improved generic authentication architecture (GAA) comprises a user equipment 14 which can communicate to a network application function (NAF) server 25 over an appropriate interface 4, for example an Ua interface. The user equipment (UE) 14 can also communicate to a bootstrapping function (BSF) server 23 via an appropriate interface 3, for example an Ub interface. The user equipment (UE) 14 can also communicate with the user security settings management (USS-MGMT) server 27 via an appropriate interface 5, for example a Ua interface. The USS-MGMT server 27 can also communicate with the bootstrapping function (BSF) server 23 via an interface 6, for example a Zn interface. The BSF server 23 can communicate to the NAF server 25 over an appropriate interface 1, for example a Zn interface. The BSF server 23 can communicate with the home subscriber server (HSS) 16 via the interface 2, for example a Zh interface. The USS-MGMT server 27 can in further embodiments of the invention be connected directly to the home subscriber server (HSS) 16 over an appropriate interface 7 (represented in FIG. 2 as a dashed line), for example a Sh or Zh interface.

The GAA is based on secret user identities that are stored on appropriate user identity modules 15 on the user equipment 14 and subscriber databases, for example the home subscriber server 16 as shown in FIG. 2, on the network side.

The exemplifying embodiments of the present invention will be described with reference to the GAA architecture as discussed in more detail below with regards to authorization of an user equipment 14 in accessing a specific application from a network application function server 25. Various possible components thereof will be described only briefly as the operation of these is not essential for embodying the invention.

The user equipment 14 communicates with an application entity, for example a network application function (NAF) server 25. The NAF server 25 is accessible by the user equipment 14 but before the network application function server 25 can deliver its services to the user equipment 14 an authentication procedure is needed. To enable this, the user equipment 14 communicates over the appropriate interface 3 with the bootstrapping server function (BSF) server 23. The bootstrapping function 23 server in response to this communication from the UE 14 communicates with a user database, such as the home subscriber server (HSS) 16 shown in FIG. 2. The application function 25 also communicates directly with the bootstrapping function 23 with the results of the bootstrapping function server (BSF) 23.

When the user equipment 14 wishes to access an application from a network application function server 25 but has not undergone an authentication before that has resulted in the BSF recovering authentication key material that is still valid, the user equipment 14 undergoes an authentication procedure by dispatching a mobile user identity to the bootstrapping function server 23. When the user equipment 14 has completed the authentication with the BSF, it accesses the application from the network application function server 25 again. The network application function server 25 in communication with the bootstrapping function server 23 requests the results of the authentication and the resulting authentication key material is sent from the bootstrapping function server 23 to the network application function server 25.

Authentication using the identities originating from the mobile network can be implemented at the bootstrapping function server 23 in various ways. The network application function server 25 can utilize the received authentication key material for direct authentication of the user.

In a possible architecture of GAA, the home subscriber server (HSS) 16 contains security related information about all the users related to all the services that use the GAA or the Generic Bootstrapping Architecture (GBA). This information may be stored in GBA user security settings (GUSS). GUSS provides a set of user security settings (USS) for a user. The set may include all security settings of the user.

A new subscriber that has not previously used a service hosted by a network application function server 25 is required to accomplish an initial service registration that results in the creation of new user security settings. The service registration is usually required before the new subscriber can start to use the service. However, as discussed previously these initial service registrations impose additional burdens for the network operators. Furthermore unless a user is not able to perform a registration directly or to edit the USS information stored, for example on the HSS 16. In the improved GAA architecture as shown in the embodiments of the invention such as shown in FIG. 2 the USS-MGNT server 27 is used to enable the user equipment 14 to access the HSS and perform the operations on the users USS information.

In the following embodiments specific examples are given how a user equipment 14 can manually or automatically manage their own GUSS data. A manual management of data can be performed by the UE contacting the USS-MGMT server 27 for example via a web interface. An automatic management mode occurs when an application, for example a network application function server 25, hosts a self-service gateway function hosted by the network operator or by a third party. The gateway function redirects the user equipment 14 to a USS-MGMT server 27 with necessary data in order to carry out the data operation, for example register the initial service parameters for example as a new service specific user security settings (USS) in the GBA user security settings (GUSS) of the subscriber in the HSS 16.

The user could, using a system as described, also could create/update an USS describing his privacy preferences, an USS describing his back-up service needs (so that the USS also stores a backup of the device data—e.g. a contacts list or address book backup, or an USS describing his specific security needs, for example the level of firewall, anti-virus or spam protection). In some embodiments of the invention the USS-MGMT server has a ‘learning’ ability—i.e. the USS is capable of being added to in order to assist in the anti-virus or spam protection.

A typical use of the present invention would be the individualization of a particular service. This may be used for example so that the user operating user equipment may personalize themselves on a messenger type system (where groups of users can communicate among each other). In such a system it is typically required that a UE 14 be authorized to send messages—to prevent a UE 14 from sending unsolicited messages, so called ‘spam’ messages.

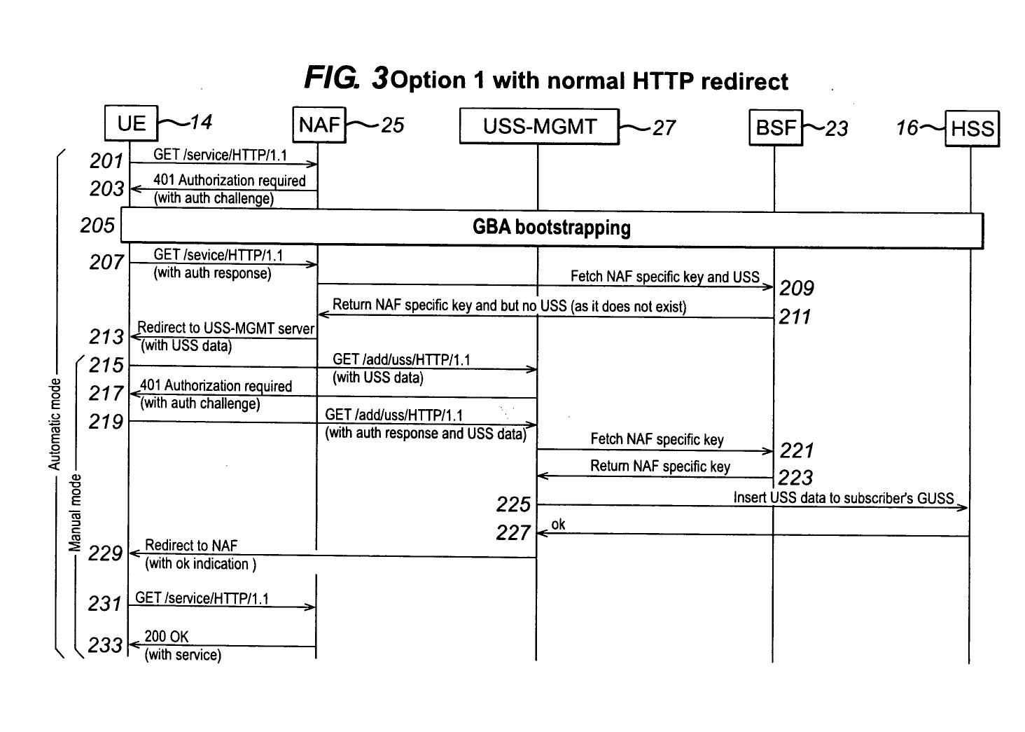

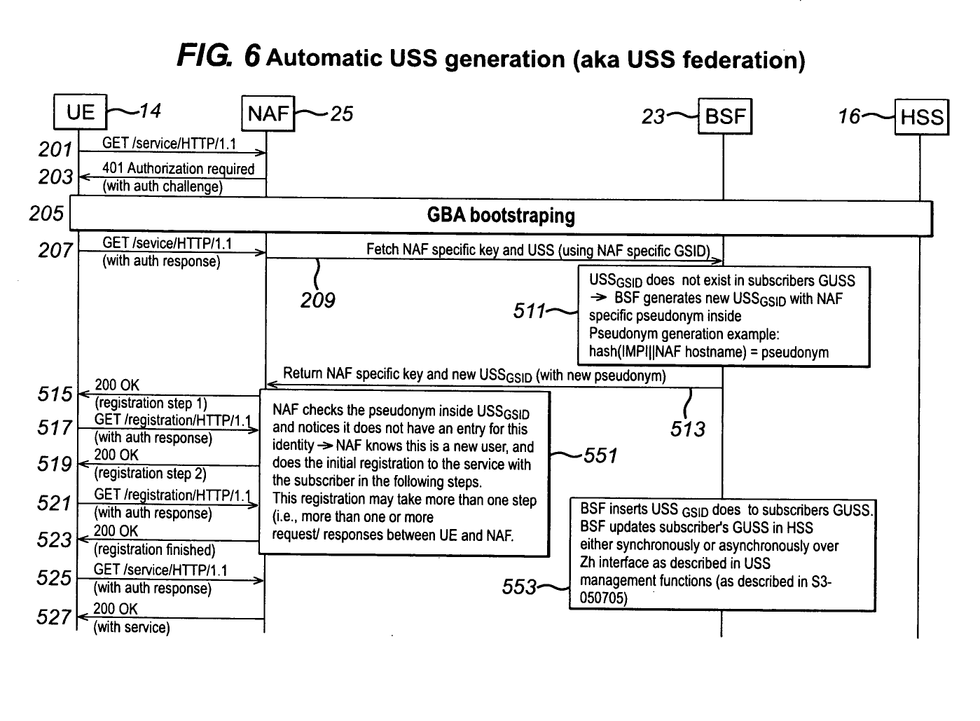

In such a system the user is able to insert their personal data, privacy preference and security needs at some self-serving portal, such as a designated USS management server. The USS-MGMT servers operating in an automatic mode then automatically perform the modification of the USS data on the HSS 16 as is described in detail below with regards to FIGS. 3 to 5. In the embodiment as shown in FIG. 6 the BSF automatically performs the modification.

The user equipment can then contact a separate NAF hosting the messenger service, this service requests if there is a USS for a service personalization and obtains the data they are allowed to receive. Additionally, they receive a token, that indicates that they are not a spammer i.e. that they are an authorized transmitter. This service is then delivered with the token and the user equipment recognizes the token and does not put the message or similar service into a spam bin.

Thus in general the self service portal (the USS-MGMT server) operates according the following steps:

Step 1 the user wants to register to a service (some NAF).

Step 2 the user is redirected with a pseudonym in URL (this may contain an authorization token) to a self service portal.

Step 3 the user inserts that data in USS and this is uploaded to the HSS as defined.

Step 4 the user is redirected back to the NAF to start to use the service.

FIG. 3 shows a flowchart describing the detail of the operation of both an automatic and manual modes of operation of the USS-MGMT server 27 in a first embodiment of the present invention. In the first embodiment the USS management functions are not available or specified within the 3GPP protocol stack thus requiring the USS-MGMT server 27 to directly access the HSS 16. The flowchart of FIG. 3 shows several steps which are taken in accordance with first embodiment for modifying by the USS-MGMT server user data in a user database but is controlled by a controlling party, for example the HSS 16 controlled by a network operator. These modifications may comprise operations such as insertion, updating and deleting of information stored in the user database. These operations are described in the prior art and are not described further.

The steps 201 to 235 of FIG. 3 show the operation of the USS-MGMT server 27 in automatic mode. The steps 215 to 235 of FIG. 3 show the manual mode of operation of the USS-MGMT server 27. As all of the steps of the manual mode of operation of the USS-MGMT server 27 are included within the automatic mode of operation we describe the automatic mode of operation where a NAF server 25 determines that there is no USS data therefore requiring a user insertion.

In step 201 the user equipment (UE) 14 transmits to an application entity a request for an application. This request can for example be a HTTP command, e.g. “GET/service/HTTP/1.1”.

The authenticity of the UE 14 is then verified. The authentication may be based for example on GBA key material communicated between the NAF server 25 and a user equipment 14, or based on a new run of GBA that authenticates the UE 14 via mobile credentials after which the network application function server 25 receives the authentication result.

Steps 203, 205, 207, 209 and 211 are steps which use known procedure to identify the user. To provide this capability to identify the user the procedure includes assignment of a user identifier or a pseudonym that can be used to identity the user in the subsequent sessions with the network application function server 25.

In step 203, the NAF 25 responds to the request by transmitting back to the UE 14 an authorization required message, the message containing an authorization challenge.

In step 205, the UE 14 performs a general bootstrapping function between the UE 14, the Bootstrapping Server Function (BSF) server 23 and the HSS 16. In this GBA bootstrapping function the UE 14, the BSF server 23 and the HSS 16 exchange information creating GBA key material in the BSF server 23 and in the UE 14.

In step 207, the UE 14, using the NAF specific key derived from GBA key material established during the bootstrapping function performed in step 205, responds to the NAF authorization required message with a further request containing an authentication response—i.e. with some information which has been provided to it during the bootstrapping function.

In step 209, the NAF server 25 transmits a request to the BSF server 23 for the NAF specific key and the USS.

Step 211 shows the example where the USS currently does not exist for example where the user equipment has not previously accessed this specific NAF server 25. Thus in step 211, the BSF server 23, in response to the request, returns the NAF specific key derived from the GBA key material and key related material (for example key lifetime) but no USS.

In step 213 the NAF server 25 transmits back to the UE 14 a message to the user equipment 14 containing a redirection to the USS-MGMT server 27. Also contained within this message is some USS data created within the NAF server 25 to be saved onto the HSS 16.

In step 215 the user equipment 14 on receiving the redirection information and the USS data to be saved on the HSS 16, then transmits to the USS-MGMT server 27 a command requesting the USS-MGMT server 27 add the USS data to the USS data currently saved on the HSS 16. This command can for example be a HTTP command, for example with the format “GET/add/uss/HTTP/1.1”. The request further comprises the USS data to be added.

In step 217 the USS-MGMT server 27 responds to the request by transmitting to the UE 14 an authorization required message containing an authorization challenge. This step is similar to that performed by the NAF server 25 in step 203.

In step 219 the UE 14, using the NAF/USS-MGMT server specific key derived from the GBA key material established during the bootstrapping function performed in step 205, responds to the authorization required message. The response is a further request to the USS-MGMT server 27, similar to the request transmitted in step 215 but comprising both the USS data and the authentication response.

In step 221 the USS-MGMT server 27 requests from the BSF server 23 the NAF specific key in order to authorize the user's request.

In step 223 the BSF server 23 returns the requested NAF specific key to the USS-MGMT server 27. Providing that the authentication response is validated with the keys the operation moves to step 225, otherwise an error message is transmitted from the USS-MGMT server 27 to the UE 14 indicating that there has been an authorization error.

In step 225 the USS-MGMT server 27 transmits a request to the HSS to insert the USS data to the subscriber's GUSS. Once this step has been successfully carried out the method passes to step 227, otherwise, if an error occurs in inserting the data an error message is passed back to the UE 14.

In step 227 the HSS 16 transmits an OK message to the USS-MGMT server 27.

In step 229 the USS-MGMT server 27 on receipt of the OK signal transmits to the UE 14 a redirection message redirecting the UE 14 back to the NAF server 25 with the message further comprising an OK indication.

In step 231 the UE 14, on receiving the redirection message transmits to the NAF server 25 a further service request message, the message is similar to the request transmitted in step 201.

In step 235 the NAF 25 responds to this further request message—the NAF server 25 has the copy of the NAF specific key and USS data in order to perform a full authorization of the UE 14. The response from the NAF server 25 is an ok message transmitted to the UE 14.

The manual mode of operation differs from the automatic mode of operation in that the for the first step of the manual mode, step 215, the UE 14 transmits the request to add USS data on the HSS 16 without having received USS data from the NAF server 25 as shown in the automatic mode. Thus in the manual mode the UE 14 generates the USS data, or the USS-MGMT server 27 can generate the USS data values. In further embodiments of the present invention the UE 14 transmits an initial request to the USS-MGMT server 27 to request current USS data from the HSS 16 with respect the subscribers GUSS. This may be displayed on the UE 14 via a www interface or an application specific interface.

If the UE has the ability to modify the subscriber's GUSS, the application functions supplied to the UE 14 can be modified to supply the specific requirements of the UE quickly and individually. Real life examples of this would be the ability to provide user specified virus and spam protection for the UE 14. Current systems enable the user to download the complete protection system, which is then adjusted on the UE if required. In the embodiments described above it would be possible for the user to modify the USS data to manage the subscriber's individual risk prior to downloading.

Furthermore this type of system would produce a better spam (unsolicited communication) blocking tool as the USS data would be able to be fine tuned to suit the individual subscriber—rather than targeting ‘mass-spam’.

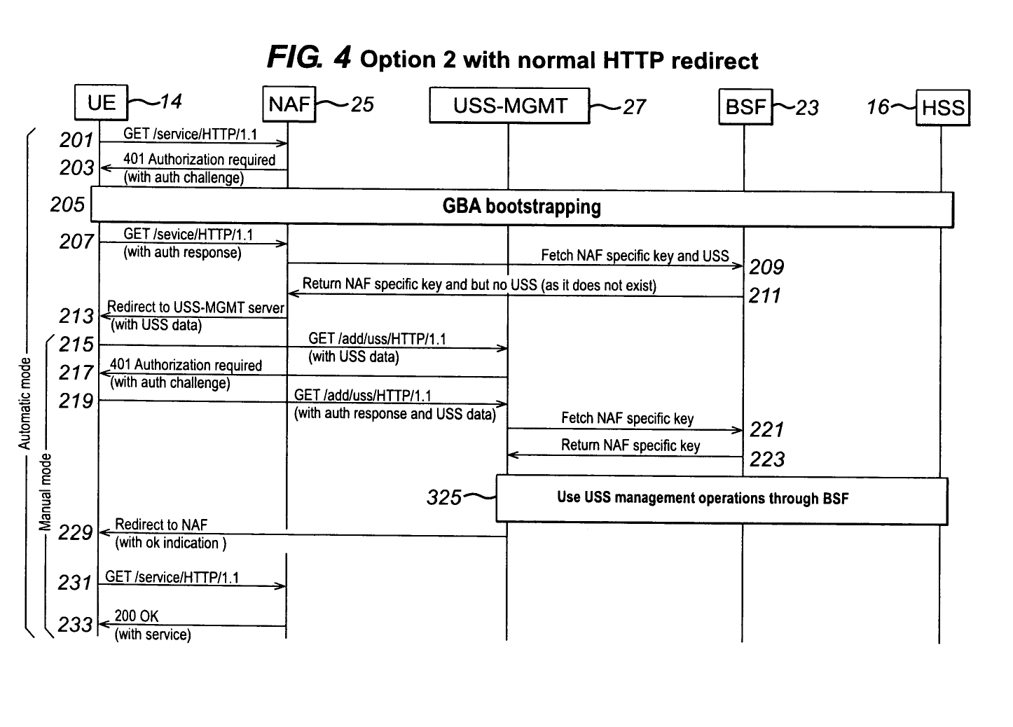

FIG. 4 shows a second embodiment of the present invention in which the USS-MGMT server utilizes USS management functions specified in 3GPP—in other words it is able to communicate with the HSS server 16 via the bootstrapping function server 23. This embodiment has therefore the additional advantage over the embodiment as described in FIG. 3 in that when the USS-MGMT server updates the HSS server it is possible to carry out a phased updating procedure. In other words the updating of the BSF server 23 can be carried out a first phase or time, and the BSF server 23 can then carry out an update of the HSS 16 at a later time. In some further embodiments of the invention the BSF server comprises a local copy of the GUSS and USS data and synchronizes the BSF copy with the HSS and/or HLR copies. In some further embodiments, the GUSS and USS data only reside in the BSF for example where the HLR and/or HSS comprises a read-only copy which can not be updated. In these embodiments, although there is no transfer of USS or GUSS data the BSF server may be still have a connection to the HLR and/or HSS in order for the BSF server to be able to obtain the necessary basic key material. An advantage of employing a multi-phased procedure is that since the USS-MGMT server 27 modifies only an internal copy of a GUSS stored in a BSF, this procedure may be substantially fast. Furthermore the modification from the BSF server 23 to the HSS 16 can be carried out following a sufficient number of updates have occurred to the BSF server's GUSS internal copy. Thus the number of modification messages going from the BSF to the HSS may be substantially smaller than the number sent from the USS-MGMT server 27 to the BSF server 23.

The messaging between the USS-MGMT server 27 and the BSF server 23, and the BSF server 23 and the HSS 16 may take place in two phases such that in a first phase, during the lifetime of a bootstrapping temporary identifier (B-TID), different USS-MGMT servers 27 may update the internal copy of the GUSS of a user in the BSF by inserting, updating, and deleting USSs. A second phase may start when the B-TID becomes invalid (e.g., expires or is replaces by a new B-TID), in response to timer, or periodically. If one or more USS-MGMT servers have modified the subscriber's GUSS or parts of it in the BSF server, the BSF server may then update the whole or part of the subscriber's GUSS in the HSS.

The steps 201 to 223 as shown in FIG. 4 are equivalent to the steps 201 to 223 as shown in FIG. 3 and described above. The major difference between the first and second embodiments is that once the USS-MGMT 27 has received the returned NAF specific key from the BSF server 23, and the UE is authorized to make the addition to the USS data, the USS-MGMT server 27 inserts the USS data to the subscriber GUSS via the BSF server 23 as can be seen in step 325. Steps 229 to 233 as shown in FIG. 4 are equivalent to the steps 229 to 233 as shown in FIG. 3 and described above.

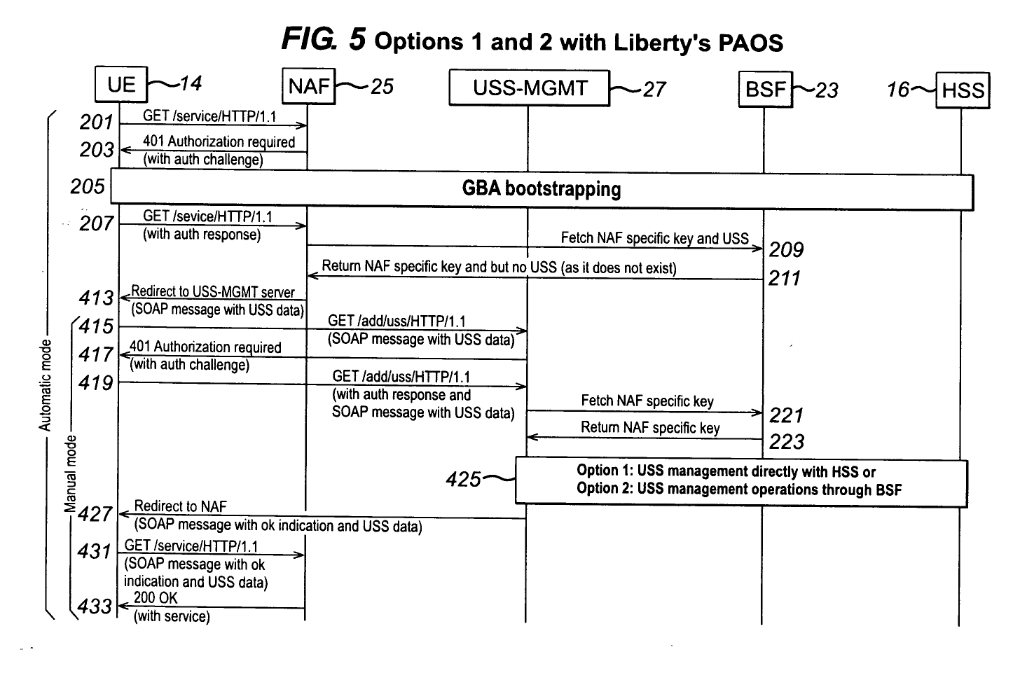

FIG. 5 shows a further embodiment of the present invention where the embodiments as shown in FIGS. 3 and 4 are further improved by the co-locating a server capable of handling Liberty project reversed http binding for simple object access protocol messages (PAOS) within the network. If the NAF/USS-MGMT server 27 and the UE 14 support PAOS (reverse HTTP binding for SOAP), then a USS management procedure may be used instead of the HTTP redirects as is done in FIGS. 3 and 4

The steps 201 to 211 in FIG. 5 are equivalent to the steps 201 to 211 in FIG. 3 as described above. The steps 413 and 415 differ from the similar steps described with respect to FIG. 3, steps 213 and 215, in that the messages are transmitted in simple object access protocol (SOAP) messages. Similarly the step 419 differs from step 219 of FIG. 3 as described above in that the message is encoded as a SOAP message. In step 425 the USS-MGMT server 27 either communicates the USS update directly as described above with respect to the first embodiment as shown in FIG. 3, or communicates the USS update via the BSF server 23 as described with respect to the second embodiment as shown in FIG. 4. Steps 427, the message transmitted from the USS-MGMT server 27 to the UE 14 to redirect the UE 14 request message to the NAF server 25, and 429, the request message transmitted from the UE 14 to the NAF server 25, differ from steps 227 and 229 as described above in that the messages are encoded as SOAP messages. In some embodiments of the present invention the SOAP messages are digitally signed.

In FIG. 6 a fourth embodiment of the present invention is shown whereby in an automatic USS generation operation the number of operations between the network entities is reduced. The steps 201, 203, 205, 207 and 209 are equivalent to the similar numbered steps as shown in the above embodiments. In step 209, the request transmitted from the NAF server 25 to the BSF server 23 to fetch the NAF server specific key and the USS data, the message contains a NAF specific GM service Identifier (GSID) value.

The fourth embodiment of the present invention differs from the previous embodiments in that the fourth embodiment in step 511 checks whether or not the BSF server 23 contains an entry for the USS associated with the GSID value of the NAF server 25. If there is no entry then the BSF server 23 generates a new USS associated with the GSID value (USS_{GSID}) with a NAF server specific pseudonym inside the newly generated USS. One example of generating a pseudonym is by applying a hash operation on the IMS public user Identity (IMPI) and NAF server hostname and security protocol identifier.

In step 513 the BSF server 23 transmits the NAF server specific key together with the newly generated USS_{GSID} containing the pseudonym.

In step 551, which contains steps 515, 517, 519, 521, and 523 the NAF server 25 checks the pseudonym inside the received USS_{GSID} data and notices that there is no entry for this identity in NAF's local databases. Thus, the NAF server 25 also determines that the UE 14 has not been registered. It then carries out the required steps to register the UE 14. The steps shown for example in FIG. 6 are step 515 where the NAF server transmits a registration request to the UE. In step 517 the UE transmits a registration response to the NAF server, for example a “GET/registration/HTTP/1.1” format request with an authorization response. In step 519 the NAF server 25 responds to the UE with an ok message indicating that a first step of registration is complete. In step 521 the UE transmits a further registration request to the NAF server, for example a “GET/registration/HTTP/1.1” format request with an authorization response. In step 523 the NAF server transmits an ok message to the UE indicating that the registration process is complete. In this example, the registration procedure contained two steps but the registration may consists of only one step in which case steps 521 and 523 are not needed, or more that two steps in which case more steps are needed between the NAF server and the UE.

In steps 525 and 527 the process between the UE and NAF server is completed. In step 525 the UE transmits a service request with an authorization response to the NAF server 25, for example a “GET/service/HTTP/1.1” format message. The NAF server, providing the steps up to this point were successfully carried out then transmits to the UE 14 an ok message which permits the requested service to be initiated.

Whilst the steps 515 to 527 are being carried out between the UE and the NAF server, in step 553 the USS_{GSID} generated in the BSF server in step 511 is inserted into the subscriber's GUSS stored in the BSF server 23. The BSF server 23 then updates the subscriber's GUSS in the HSS 16 either synchronously or asynchronously between the BSF and the HSS over the Zh interface.

In some embodiments of the present invention the communication between the USS-MGMT server 27 and the BSF server 23 may be performed in a secure communication channel, for example using HTTPS (Hypertext Transport Protocol Security), MAP/Sec (Mobile Application Part Security) or IPSec (Internet Protocol Security). In some embodiments of the present invention the transfer of messages occur in an synchronous network. In other embodiments of the present invention the messaging between the USS-MGMT server and the HSS is asynchronous. In some embodiments of the present invention the USS-MGMT server 27 is only authorized to perform some management procedures, but not others. For example the user may via the USS-MGMT server 27 update the USS but not be permitted to delete USS data.

The arrangement may be such that each NAF has the right to modify only certain parts of the GUSS data. The BSF may also only allow one NAF or certain NAFs at the time to modify the content of the GUSS data. The BSF may also restrict modifications to dedicated USS or may allow management actions for a larger set of USSs.

If there are several user databases such as home subscriber servers in an operator system, then the BSF and/or the USS-MGMT server may need to know which server to contact. This information may be provided, for example, by a Subscriber Locator Function (SLF). The BSF/USS-MGMT server may contact the SLF with the request for data and be then provisioned with necessary information or redirected to the right HSS that contains the corresponding user data. The interface between BSF/USS-MGMT server and SLF may be, for example, a Dz or similar interface. It may also be possible, that the BSF keeps a local copy of the USS and GUSS data.

The above described operations may require data processing in the various entities. The data processing may be provided by means of one or more data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a location server.

The above embodiments relate to use cases where user data of a user using a service application is modified, either during initial registration or afterwards. User data may be managed accordingly also when the user is not using the service, but modification of user data is desired.

In some embodiments of the present invention the USS-MGMT and NAF functionality is housed within a single server entity: In this embodiment the USS-MGMT part is responsible for managing USS data, and the NAF functionality is used to authenticate the UE. In other embodiments of the present invention the USS-MGMT server can be without any NAF functionality, but then it must authenticate the UE by some other means, and it must use interface 7 to modify GUSS in HSS.

It is noted that whilst in the above embodiments are described in relation to user equipment such as mobile stations, embodiments of the present invention are applicable to any other suitable type of user equipment.

It is also noted that even though the exemplifying communication system shown and described in more detail in this disclosure uses the terminology of the 3^{rd} generation (3G) WCDMA (Wideband Code Division Multiple Access) networks, such as UMTS (Universal Mobile Telecommunications System) or CDMA2000 public land mobile networks (PLMN), embodiments of the proposed solution can be used in any communication system wherein advantage may be obtained by means of the embodiments of the invention. The invention is not limited to environments such as cellular mobile or WLAN systems either.

It is also noted that while the above describes exemplifying embodiments of the invention, there are several variations and modifications which may be made to the disclosed solution without departing from the scope of the present invention as defined in the appended claims.

1. A method for managing, from a user equipment, user security data stored in a database of a communications system, comprising:
receiving from the user equipment a request to manage the user security data;
authenticating the user equipment in an application entity; and
managing, by an application entity, user security data in a database associated with the user equipment by communicating data between the application entity and a database connected to the communications system.

2. A method according to claim 1, wherein communicating data comprises:
communicating data between the application entity and a security management function, and
communicating data between a security management function and the database.

3. A method according to claim 2, comprising modifying user data by the security management function.

4. A method according to claim 2, wherein the security management function comprises a bootstrapping function.

5. A method according to claim 1, wherein communicating data comprises communicating data on an interface directly connecting the application entity and the user database.

6. A method according to claim 1, wherein managing user security data comprises:
modifying a copy of the user security data in a second database within the application entity;
communicating the copy of the user security data from the second database to database managed by the main controller; and
modifying the user security data in the database managed by the main controller based on the copy of the user security data from the second database.

7. A method according to claim 6, wherein communicating the copy of the user security data occurs in response to a predefined event.

8. A method according to claim 7, wherein the predefined event comprises an end of session between the application entity and the user.

9. A method according to claim 1, wherein authenticating comprises authenticating the user in a bootstrapping function based on security keys.

10. A method according to claim 1, wherein the main controller comprises a network operator.

11. A method according to claim 1, wherein the database connected to the communication system is controlled by the main controller and is provided in a home subscriber server.

12. A method according to claim 1, wherein managing is performed when the user starts using a new service application.

13. A method according to claim 1, comprising authentication of the user in a generic authentication architecture (GAA) in accordance with specifications of the third generation partnership project (3GPP).

14. A method according to claim 1, wherein the user security data comprises user security settings.

15. A method according to claim 14, wherein the user security data comprises service specific user security settings of a generic bootstrapping architecture user security settings.

16. A method according to claim 1, comprising fetching information regarding a user database to be managed in a communications system comprising a plurality of user databases.

17. A method according to claim 16, comprising fetching said information from a subscriber locator function to a security management function.

18. A computer program embodied on a computer readable medium, the computer program executing a program configured to perform:
receiving from the user equipment a request to manage the user security data;
authenticating the user equipment in an application entity; and
managing, by an application entity, user security data in a database associated with the user equipment by communicating data between the application entity and a database connected to the communications system.

19. A first node for a communications system where user security data is stored in a database stored on a second node, the first node being configured to receive an input from a user equipment to manage user security data associated with an authenticated user, and to manage user security data associated with the authenticated user in the database by communicating data to the database connected to the communications system.

20. A first node according to claim 19 configured to modify user security data in a second database stored in a third node for later communication from the second database to a database stored on the second node.

21. A first node according to claim 19, wherein the third node comprises a security management function.

22. A first node according to claim 21, wherein the security management function comprises a bootstrapping function.

23. A first node according to claim 19, wherein the third node comprises the user database, and the first node is provided with an interface directly connecting the first node and the user database.

24. A first node according to claim 19, wherein the first node is configured to manage user security data when the user starts using a new application.

25. A first node according to claim 19, wherein the node is configured to authenticate a user based on a generic authentication architecture (GAA) in accordance with specifications of a third generation partnership project (3GPP) or third generation partnership project 2 (3GPP2).

26. A first node according to claim 19, wherein the user security data comprises user security settings.

27. A first node according to claim 26, wherein the user security data comprises service specific user security settings of a generic bootstrapping architecture user security settings.

28. A first node according to claim 19, comprising a USS management server.

29. A communications system, comprising: a first node configured to receive an input from a user equipment to manage user security data associated with an authenticated user;
a second node configured to store the user security data in a database on the second node;
a receiving unit configured to receive a request from a user equipment to manage the user security data;
an authenticating unit configured to authenticate the user equipment in an application entity; and
an application entity configured to manage the user security data in a database associated with the user equipment by communicating data between the application entity and a database connected to the communications system.

30. An apparatus for managing, from a user equipment, user security data stored in a database of a communications system, comprising:
means for receiving from the user equipment a request to manage the user security data;
means for authenticating the user equipment in an application entity; and
means for managing, by an application entity, user security data in a database associated with the user equipment by communicating data between the application entity and a database connected to the communications system.
